(19) United States
(12) Patent Application Publication
(10) Pub. No.: US 2022/0040031 A1
(43) Pub. Date: Feb. 10, 2022

(54) MUSCLE MASSAGING BELT ASSEMBLY

(71) Applicant: NATALIE HUANG, CHINO HILLS, CA (US)

(72) Inventor: NATALIE HUANG, CHINO HILLS, CA (US)

(21) Appl. No.: 17/394,699

(22) Filed: Aug. 5, 2021

Related U.S. Application Data
(60) Provisional application No. 63/061,774, filed on Aug. 5, 2020.

(51) Int. Cl. A61H 11/00; A61H 23/02

(52) U.S. Cl. CPC A61H 11/00; A61H 23/02; A61H 2201/12; A61H 2205/06; A61H 2205/08; A61H 2205/10; A61H 2201/165

(57) ABSTRACT

A muscle massaging belt assembly is designed to be worn around a person's torso or limbs. A buckle member and latch member of the belt assembly is designed to be coupled or uncoupled. A variable length strap portion of the belt assembly is slidably looped back from the buckle or latch member and is designed to be shortened or lengthened to increase or decrease the circumference of the fastened buckle and latch members. A detachable, laterally extendable or expandable, planar platform is disposed in a substantially middle portion of the belt assembly, a rechargeable battery disposed within. One or more mounting assemblies are disposed on an inner face of the platform. A plurality of detachable knob assemblies is coupled to the mounting assemblies, a battery assembly disposed within, a top of each knob designed to abut the torso or a limb of a user. An electric vibration motor is within each knob assembly.

### CLAIM OF PRIORITY

This application claims priority to and the benefit of U.S. Provisional Application with Ser. No. 63/061,774, filed on Aug. 5, 2020 with entitled MUSCLE MASSAGING BELT, the contents of which are incorporated herein by reference in its entirety.

### FIELD OF THE INVENTION

The inventive concept relates generally to a muscle massaging belt.

### BACKGROUND

Currently, there are a number of solutions for muscle massagers. One of these solutions attempts to utilize a masseuse, but this solution fails to meet the needs of the market because masseuses are expensive and must be scheduled. Another solution attempts to utilize a massage chair, but this solution is similarly unable to meet the needs of the market because massage chairs may not target the right spots. Still another solution seeks to utilize a roller, but this solution also fails to meet market needs because rollers cannot reach the whole body and require human power. Therefore, there currently exists a need in the market for an apparatus that massages muscles.

### SUMMARY OF THE INVENTION

In one example embodiment, there is provided a muscle massaging belt assembly which includes a strap and clip assembly designed to be worn around a person's torso or limbs with a strap portion and a clip portion. A buckle member of the clip portion is coupled to a first attachment end of the strap and clip assembly, and a latch member of the clip portion is coupled to a lengthwise opposite attachment end of the strap and clip assembly. The buckle member and the latch member are designed to be in a coupled or uncoupled state. A variable length portion of the strap portion of the strap and clip assembly is slidably looped back from the one or more of the buckle or latch member, designed to be shortened or lengthened to increase or decrease the circumference of the strap and clip assembly when the buckle and latch members are in a coupled state. A detachable, laterally extendable or expandable, substantially planar platform assembly is disposed in a substantially middle portion of the strap and clip assembly, there being a platform rechargeable battery assembly disposed within the platform assembly. One or more mounting assemblies are disposed on an inner face of the platform assembly. A plurality of detachable knob assemblies is designed to be removably coupled to the mounting assemblies at a base portion of the knob assemblies. A knob rechargeable battery assembly is disposed within each knob assembly. A top portion of each knob assembly is designed to substantially abut the torso or a limb of the strap and clip wearer. An electric motor assembly with an eccentrically mounted weight portion is disposed within each knob assembly and electrically connected to one or more rechargeable battery assemblies, the electric motor assembly designed to vibrate the knob assembly.

In one embodiment of the muscle massaging belt assembly, the plurality of detachable knob assemblies includes one or more of a thumb, cone, wedge, ball, or rollerball configurations.

In one embodiment of the muscle massaging belt assembly, a second buckle assembly is disposed within the strap portion of the strap and clip assembly and designed to be coupled to the variable length of the strap portion of the strap and clip assembly that is slidably looped back and designed to be shortened or lengthened to increase or decrease the available circumference of the strap and clip assembly when the buckle and latch members are in a coupled state.

In one embodiment of the muscle massaging belt assembly, an adjustable strap assembly for a hand is included within a kit assembly including the strap and clip assembly. The strap assembly is coupled to at least one mounting assembly, the mounting assembly designed to removably coupled to one or more of the knob assemblies. In this embodiment, the kit assembly may include one or more knob assemblies configured as a claw or a scraper. In one embodiment of the muscle massaging belt assembly, the platform assembly and the plurality of knob assemblies each include at least one recharging port assembly and at least one actuator assembly. The knob assemblies may operate independently or may be actuated by the actuator on the platform assembly.

Rubber material may be used in the inventive concept to feel human-like. Selected vibrational frequencies may be used such as 120 Hz to properly promote muscle relaxation and help with pain.

It would be advantageous to have a muscle massaging belt assembly that is interchangeable. Furthermore, it would also be advantageous to have a muscle massaging belt assembly that is adjustable. Still further, it would be advantageous to have a muscle massaging belt assembly that is rechargeable.

The muscle massaging belt assembly advantageously fills the aforementioned deficiencies by providing a muscle massaging belt, which provides a wearable device to pinpoint tense muscles.

The muscle massaging belt assembly may have one or more USB charging ports.

The muscle massaging belt assembly fulfills the need for a muscle-relaxing belt.

Among other things, it is an advantage of the muscle massaging belt assembly to provide a muscle massaging belt that does not suffer from problems or deficiencies associated with prior solutions.

It is still further an advantage of the muscle massaging belt assembly to be compact.

Still further, the muscle massaging belt assembly has a hand-held applicator.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIG. 1 illustrates the front of the muscle massaging belt assembly.

FIG. 2 illustrates the back of the muscle massaging belt assembly.

FIG. 3 illustrates the right side of the muscle massaging belt assembly.

FIG. 4 illustrates the left side of the muscle massaging belt assembly.

FIG. 5 illustrates the top of the muscle massaging belt assembly.

FIG. 6 illustrates the bottom of the muscle massaging belt assembly.

FIG. 7 illustrates the perspective view of the muscle massaging belt assembly.

FIG. 8 illustrates the front of the knob.

FIG. 9 illustrates the top of the knob.

FIG. 10 illustrates the bottom of the knob.

FIG. 11 illustrates the perspective view of the knob.

FIG. 12 illustrates the charging ports and the actuators.

FIG. 13 illustrates the electric motor assembly with an eccentrically mounted weight portion.

FIG. 14 illustrates the assortment of knob assemblies.

FIG. 15 illustrates the kit assembly of the muscle massaging belt.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

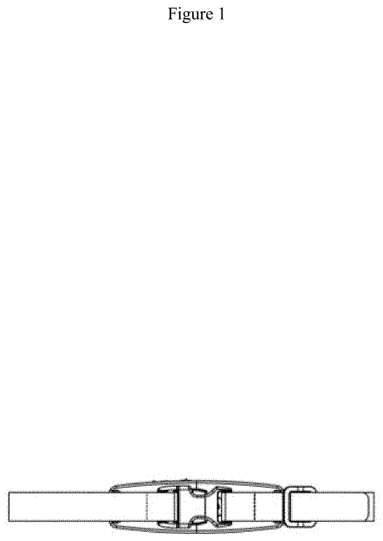

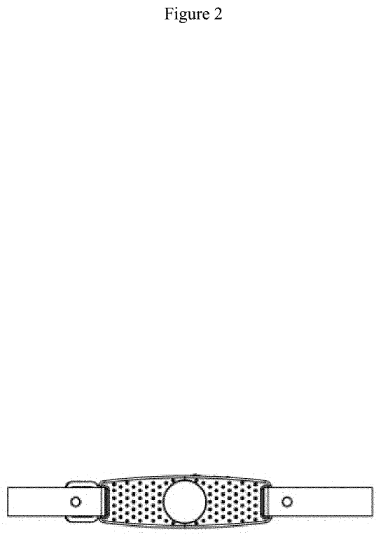

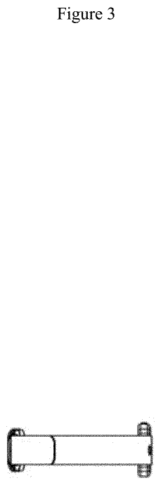

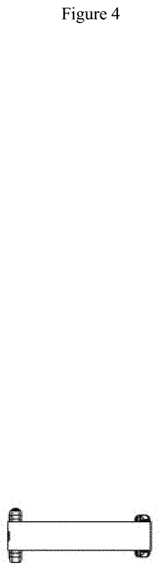

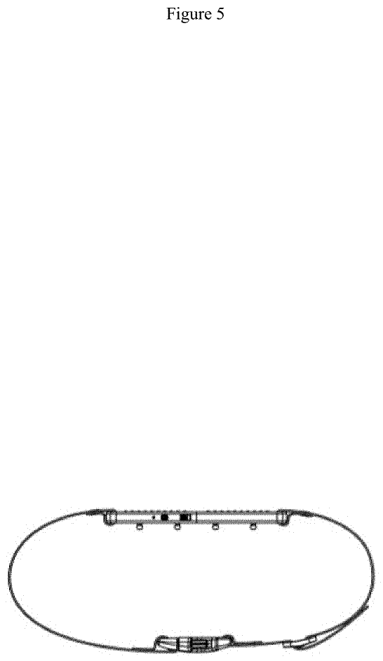

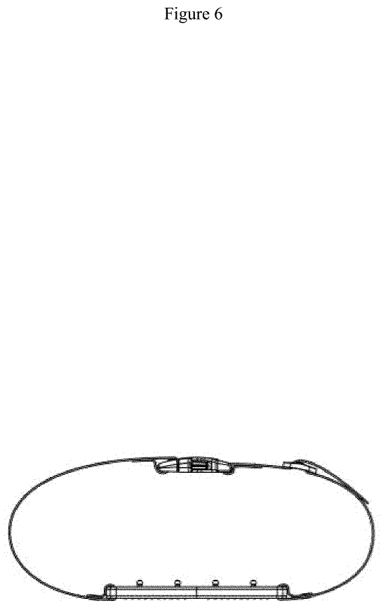

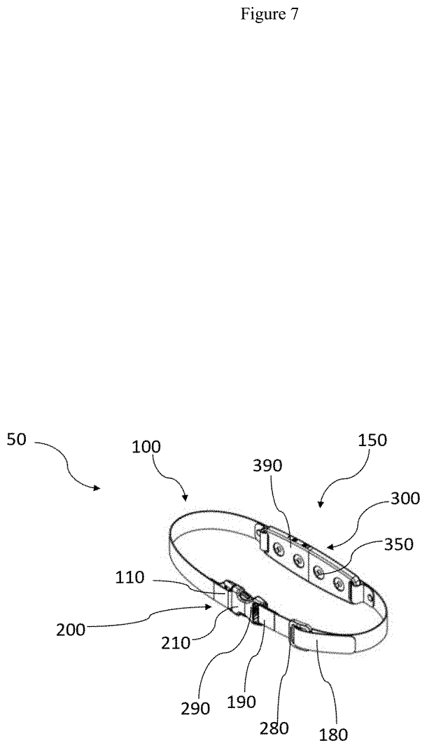

Referring to the figures, FIGS. 1-7 illustrate a muscle massaging belt assembly 10 that includes a strap and clip assembly 50 designed to be worn around a person's torso or limbs with a strap portion 100 and a clip portion 200. A buckle member 210 of the clip portion 200 is coupled to a first attachment end of the strap and clip assembly 110 and a latch member 290 of the clip portion 200 is couple to a lengthwise opposite attachment end of the strap and clip assembly 190, the buckle member 210 and the latch member 290 designed to be in a coupled or uncoupled state. In this embodiment, a second buckle assembly 280 is disposed within the strap portion of the strap and clip assembly 50 and designed to be coupled to a variable length of the strap portion of the strap and clip assembly 180 that is slidably looped back and designed to be shortened or lengthened to increase or decrease the available circumference of the strap and clip assembly 50 when the buckle and latch members 210, 290 are in a coupled state.

In this example embodiment, there is included a detachable, laterally extendable, substantially planar platform assembly 300 is disposed in a substantially middle portion of the strap and clip assembly 150, a platform rechargeable battery assembly 330 disposed within the platform assembly 300, one or more mounting assemblies 350 disposed on an inner face of the platform assembly 390.

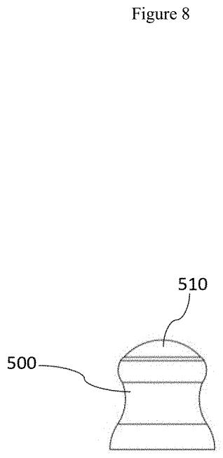

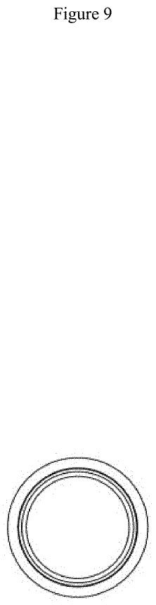

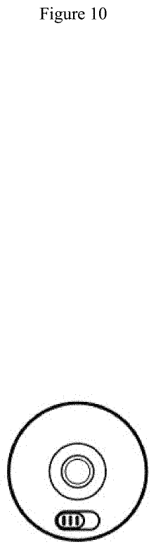

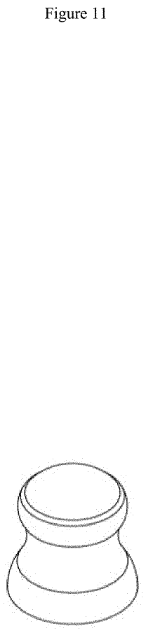

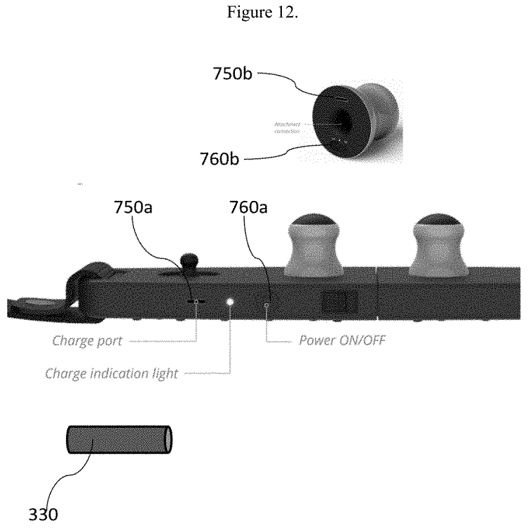

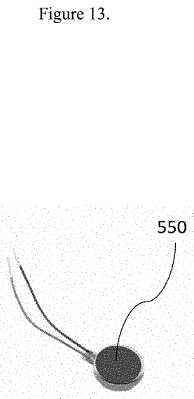

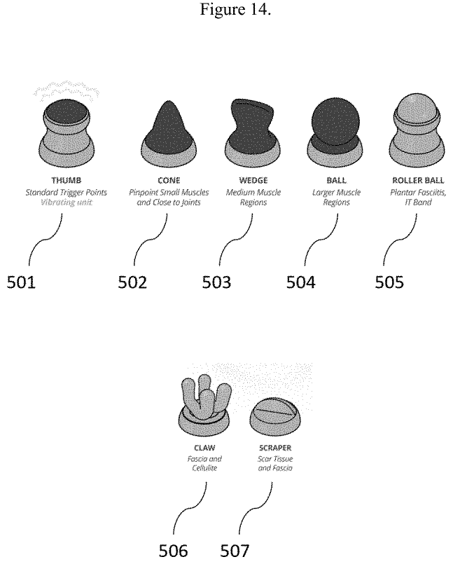

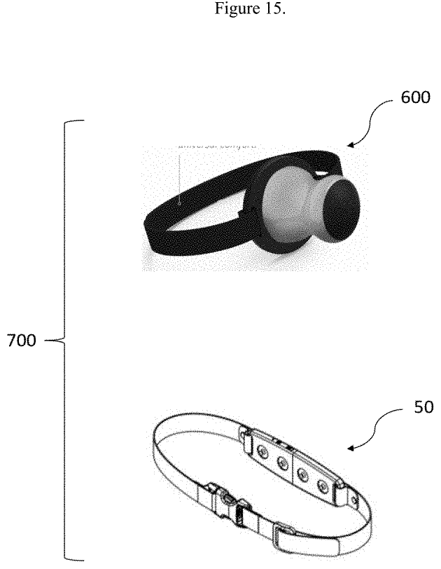

Referring now to FIGS. 8-15, a plurality of detachable knob assemblies 500 is designed to be removably coupled to the mounting assemblies 350 at a base portion of the knob assemblies 500, a knob rechargeable battery assembly 530 disposed within each knob assembly 500, a top portion of each knob assembly 510 designed to substantially abut the torso or a limb of the strap and clip wearer. An electric motor or vibration assembly with an eccentrically mounted weight portion 550 is disposed within each knob assembly 500 and electrically connected to one or more rechargeable battery assemblies 330, 530, the electric motor assembly 550 designed to vibrate the knob assembly 500.

In one embodiment of the muscle massaging belt assembly, the plurality of detachable knob assemblies 530 includes one or more of a thumb 501, cone 502, wedge 503, ball 504, or rollerball configurations 505.

In this embodiment of the muscle massaging belt assembly, an adjustable strap assembly for a hand 600 is included within a kit assembly 700 including the strap and clip assembly 50. The strap assembly 100 is coupled to at least one mounting assembly 350, the mounting assembly 350 designed to removably couple to one or more of the knob assemblies 500. In this embodiment, the kit assembly 700 may include one or more knob assemblies 500 configured as a claw 506 or a scraper 507. In this embodiment of the muscle massaging belt assembly, the platform assembly 300 includes at least one recharging port assembly 750a and at least one actuator assembly 760a, and the plurality of knob assemblies 500 each include at least one recharging port assembly 750b and at least one actuator assembly 760b. The knob assemblies 500 may operate independently or may be actuated by the actuator on the platform assembly 760a.

In a related embodiment, the expandable planar platform is configured to be expandable vertically or longitudinally. The following patents are incorporated by reference in their entireties: U.S. Pat. No. 6,866,644, 20180256442A1, and D841829.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A muscle massaging belt assembly comprising:
a strap and clip assembly adapted to be worn around a person's torso or limbs with a strap portion and a clip portion, a buckle member of the clip portion coupled to a first attachment end of the strap and clip assembly and a latch member of the clip portion couple to a lengthwise opposite attachment end of the strap and clip assembly, the buckle member and the latch member adapted to be in a coupled or uncoupled state;
a variable length portion of the strap portion of the strap and clip assembly slidably looped back from the one or more of the buckle or latch member and adapted to be shortened or lengthened to increase or decrease the circumference of the strap and clip assembly when the buckle and latch members are in a coupled state;
a detachable, laterally extendable or expandable, substantially planar platform assembly disposed in a substantially middle portion of the strap and clip assembly, a rechargeable battery assembly disposed within the platform assembly, one or more mounting assemblies disposed on an inner face of the platform assembly;
a plurality of detachable knob assemblies adapted to be removably coupled to the mounting assemblies at a base portion of the knob assemblies, a rechargeable battery assembly disposed within each knob assembly, a top portion of each knob assembly adapted to substantially abut the torso or a limb of the strap and clip wearer; and
an electric motor or vibration assembly with an eccentrically mounted weight portion disposed within each knob assembly and electrically connected to one or more rechargeable battery assemblies, the electric motor assembly adapted to vibrate the knob assembly.

2. The muscle massaging belt assembly of claim 1 wherein the plurality of detachable knob assemblies includes one or more of a thumb, cone, wedge, ball, and rollerball configurations.

3. The muscle massaging belt assembly of claim 1 wherein a second buckle assembly is disposed within the strap portion of the strap and clip assembly and adapted to be coupled to the variable length of the strap portion of the strap and clip assembly that is slidably looped back and adapted to be shortened or lengthened to increase or decrease the available circumference of the strap and clip assembly when the buckle and latch members are in a coupled state.

4. The muscle massaging belt assembly of claim 1 wherein an adjustable strap assembly for a hand is included within a kit assembly including the strap and clip assembly, the strap assembly coupled to at least one mounting assembly, the mounting assembly adapted to removably coupled to one or more of the knob assemblies.

5. The muscle massaging belt assembly of claim 4 wherein the kit assembly includes one or more knob assemblies configured as a claw or a scraper.

6. The muscle massaging belt assembly of claim 1 wherein the platform assembly and the plurality of knob assemblies each include at least one recharging port assembly and at least one actuator assembly.
